(19) United States
(12) Patent Application Publication
(10) Pub. No.: US 2006/0210367 A1
(43) Pub. Date: Sep. 21, 2006

(54) Wood boring operation aid

(76) Inventor: Hsu Hsiu-Kwei Liu, Taichung (TW)

Correspondence Address: TROXELL LAW OFFICE PLLC, SUITE 1404, 5205 LEESBURG PIKE, FALLS CHURCH, VA, 22041, US

(21) Appl. No.: 11/082,694

(22) Filed: Mar. 18, 2005

(51) Int. Cl. B23B 47/28

(52) U.S. Cl. 408/115 R

(57) ABSTRACT

A wood boring operation aid includes bore-locating templates, translation-control cross shafts, a bore-locating block, a boring guide sleeve, a peg, mounting blocks, and locking screws assembled together for mounting on a workpiece to make bores. The boring guide sleeve is externally threaded for screwing into a threaded hole on the bore-locating block without the risk of loosening from the bore-locating block during the boring operation. The translation-control cross shafts are provided with measuring marks, which could be observed via through screw holes provided near two longitudinal ends of the bore-locating templates to determine the new positions of the bore-locating templates translated along the translation-control cross shafts. And, holes provided along the bore-locating templates for locating positions for boring are sequentially numbered to enable quick and correct insertion of a peg into a desired hole.

### FIELD OF THE INVENTION

The present invention relates to a wood boring operation aid, and more particularly to a wood boring operation aid that enables a user to quickly and firmly fix a boring guide sleeve in a bore-locating block without using any hand tool, easily determine whether a bore-locating template has been translated to a desired position for boring without using any measuring rule, and easily insert a peg into one of many holes on a bore-locating template to indicate a desired position for boring.

### BACKGROUND OF THE INVENTION

FIG. 1 shows a bore-locating block 60 and a boring guide sleeve 62 included in a conventional wood boring operation aid for mounting on a workpiece 15 to make bores, as shown in FIG. 2. The bore-locating block 60 is provided on a top with a vertical hole 601, and on an end surface with a horizontal hole 602 communicating with the vertical hole 601. The boring guide sleeve 62 is inserted into the vertical hole 601 and held therein by a screw 63 sideward screwed into the horizontal hole 602 to press against an outer surface of a lower round body of the boring guide sleeve 62. The screw 63 tends to loosen or even separate from the lower round body of the boring guide sleeve 62 and fails to firmly hold the boring guide sleeve 62 in the vertical hole 601 during a boring operation due to vibration caused by a boring bit extended into an axial hole provided on the boring guide sleeve 62. Moreover, when it is necessary to replace the boring guide sleeve 62 with another one, a user has to dismount the screw 63 and then tighten it again. This is, of course, very inconvenient for the user to do so.

The conventional wood boring operation aid shown in FIG. 2 includes, for example, two bore-locating templates 4 having a plurality of spaced holes 5 provided along it, and two translation-control cross shafts 10 extended through two longitudinal ends of the bore-locating templates 4 and locked at two ends to two opposite sides of the workpiece 15. The bore-locating template 4 is guided by the two translation-control cross shafts 10 to translate to a position on the workpiece 15 at where bores are to be made. When the bore-locating template 4 is moved to a desired position, a user has to check and determine its new position on the workpiece 15 by using a measuring rule 28 to measure from one side of the workpiece 15 to a centerline of the holes 5 on the bore-locating template 4. This procedure is time-consuming and causes inconveniences to the user.

As shown in FIG. 3, the holes 5 provided along the bore-locating template 4 are not numbered to indicate their sequential position on the bore-locating template 4. When a user needs to insert a peg 44 into one of the holes 5 to mark the position at where a bore is to be made on the workpiece 15, it is very possibly the user makes mistake in counting the holes 5 and results in an incorrect boring position on the workpiece 15.

The above-mentioned conventional wood boring operation aid being described with reference to FIGS. 1, 2, and 3 is disclosed in U.S. Pat. No. 5,056,966 in FIG. 5 (elements 60, 62, and 63), FIG. 1 (elements 28, 35, and 37), and FIG. 5 (element 5) thereof (see the attached sheets).

### SUMMARY OF THE INVENTION

A primary object of the present invention is to provide a wood boring operation aid, with which a user could quickly and firmly fix a boring guide sleeve in a bore-locating block without using any hand tool.

Another object of the present invention is to provide a wood boring operation aid, with which a user could easily determine whether a bore-locating template has been translated to a desired position for boring without using any measuring rule.

A further object of the present invention is to provide a wood boring operation aid, with which a user could easily insert a peg into one of many holes on a bore-locating template to indicate a desired position for boring without the need of counting the holes one by one.

To achieve the above and other objects, the wood boring operation aid according to the present invention includes at least one bore-locating template, two translation-control cross shafts, a bore-locating block, a boring guide sleeve, a peg, two sets of mounting blocks, and a plurality of locking screws assembled together for mounting on a workpiece to make bores. The boring guide sleeve is externally threaded for screwing into a threaded hole provided on the bore-locating block without the risk of loosening from the bore-locating block during the boring operation. The translation-control cross shafts are provided with measuring marks, which could be observed via through screw holes provided near two longitudinal ends of each bore-locating template to locate on a centerline of a row of holes provided along the bore-locating template and immediately above the translation-control cross shafts, so as to determine the new positions of the bore-locating templates having been translated along the translation-control cross shafts. And, the row of holes provided along each bore-locating template for locating positions for making bores are sequentially numbered to enable quick and correct insertion of a peg into a desired hole.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a bore-locating block and a boring guide sleeve included in a conventional wood boring operation aid, and the manner in which the boring guide sleeve is held in the bore-locating block;

FIG. 2 is a perspective view of a conventional wood boring operation aid showing a measuring rule is used to determine the new position of a translated bore-locating template;

FIG. 3 is a fragmentary perspective view showing the insertion of a peg into one of many holes provided along the bore-locating template of the conventional wood boring operation aid of FIG. 2;

FIG. 4 is an exploded perspective view of a wood boring operation aid according to the present invention;

FIG. 5 is an assembled perspective view of FIG. 4;

FIG. 6 shows the insertion of a boring bit into a boring guide sleeve on the wood boring operation aid of the present invention;

FIG. 7 is a fragmentary and enlarged perspective view of the wood boring operation aid of the present invention showing the observation of measuring marks on a translation-control cross shaft thereof via a screw hole provided on a bore-locating template fixed thereto; and

FIG. 8 shows the insertion of a peg into one of many numbered holes provided along the bore-locating template of the wood boring operation aid of the present invention.

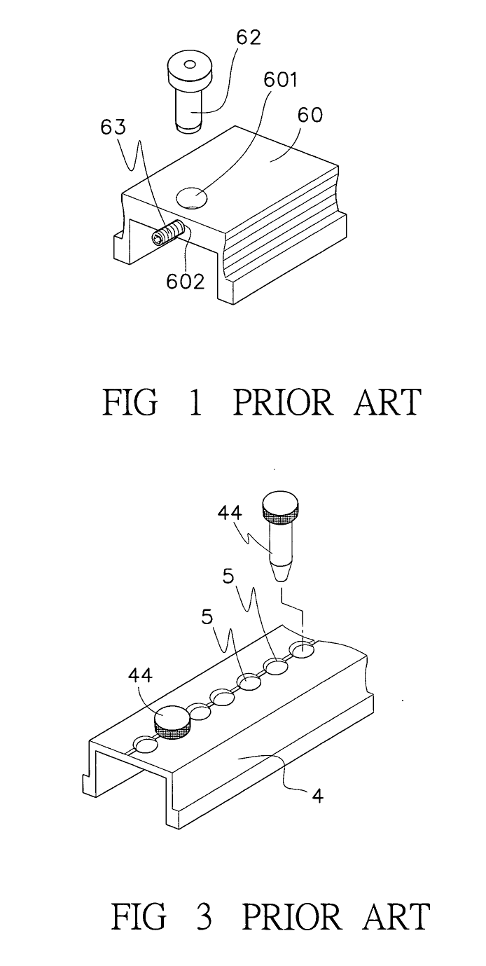

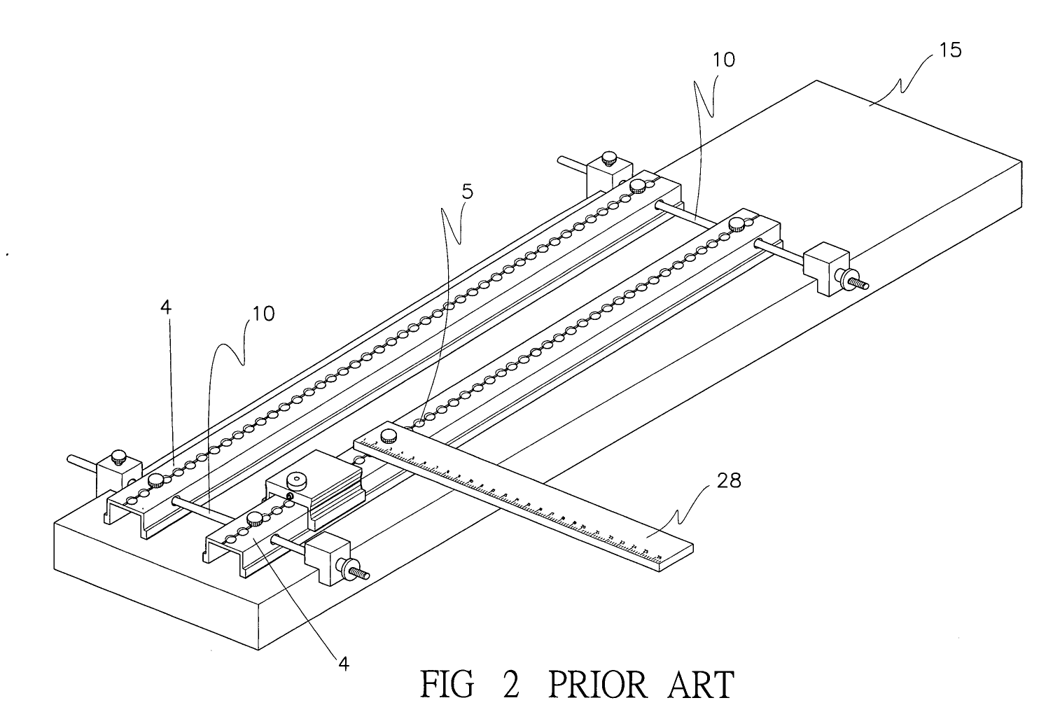

### DETAILED DESCRIPTION OF THE PREFERRED EMBODIMENTS

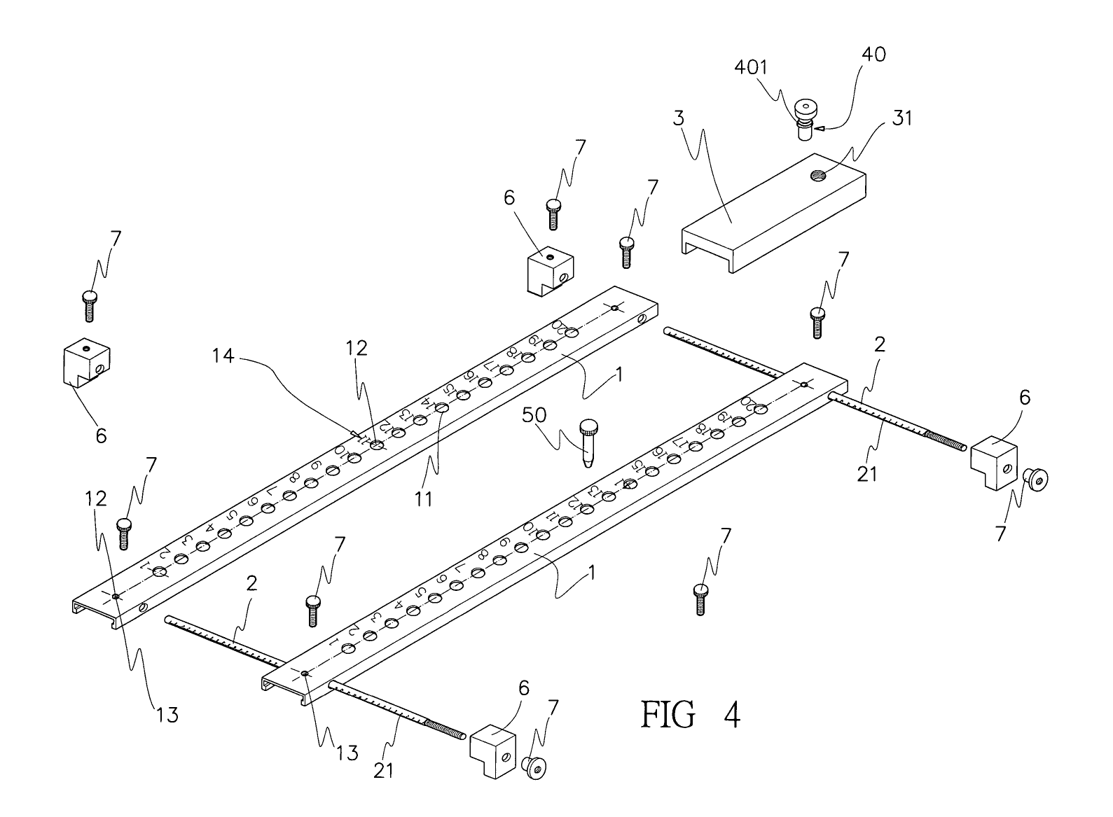

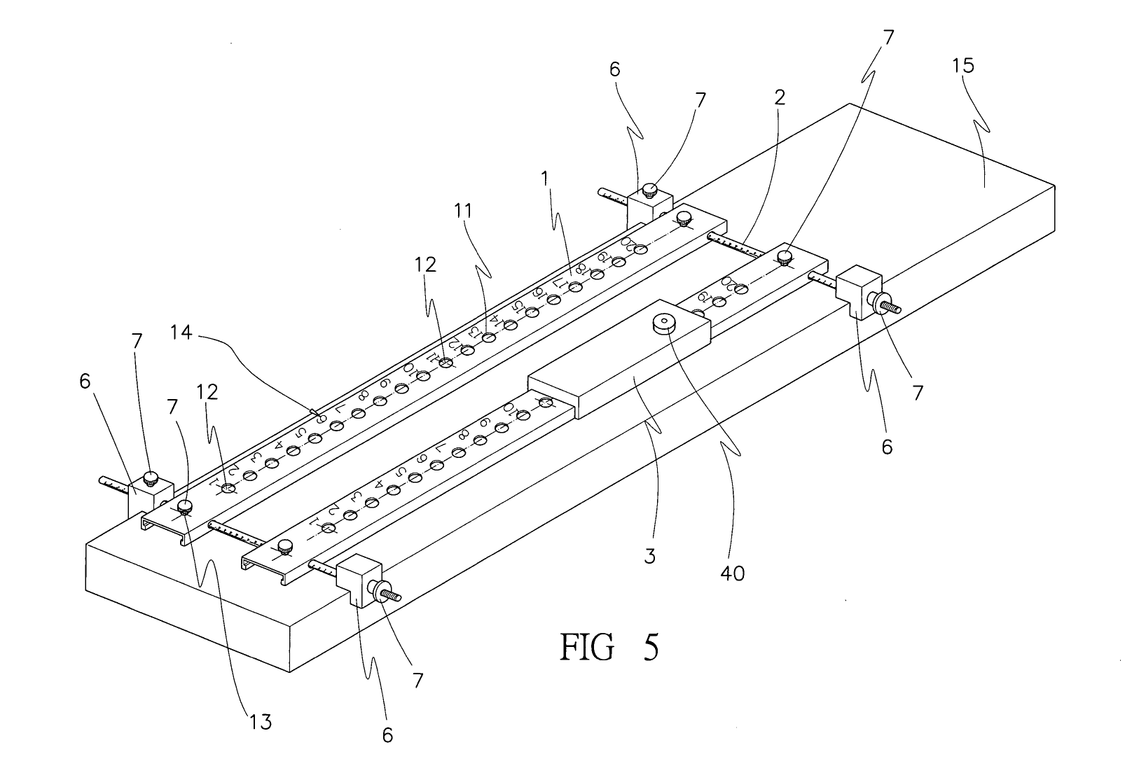

Please refer to FIGS. 4 and 5 that are exploded and assembled perspective views, respectively, of a wood boring operation aid according to the present invention. As shown, the wood boring operation aid of the present invention mainly includes at least one bore-locating template 1 having a row of spaced holes 11 provided along it, two translation-control cross shafts 2 connected to two ends of each bore-locating template 1 and firmly locked at two ends to two opposite sides of a workpiece, at least one bore-locating block 3 movably mounted on the bore-locating template 1, at least one boring guide sleeve 40 for screwing into the bore-locating block 3, at least one peg 50 for selectively inserting into one of the holes 11 on the bore-locating template 1, at least two sets of mounting blocks 6 for tightly locking the translation-control cross shafts to two opposite sides of the workpiece, and a plurality of locking screws 7 for tightening the mounting blocks 6 against the workpiece and the bore-locating template 1 against the translation-control cross shafts 2.

The bore-locating block 3 is provided at a top surface with an internally threaded through hole 31, and the boring guide sleeve 40 is provided on an outer surface of a lower round body with threads 401 meshing with the internally threaded through hole 31, so that the boring guide sleeve 40 could be directly clockwise screwed into the through hole 31 on the bore-locating block 3 and firmly held therein without using any hand tool, such as a hexagonal wrench.

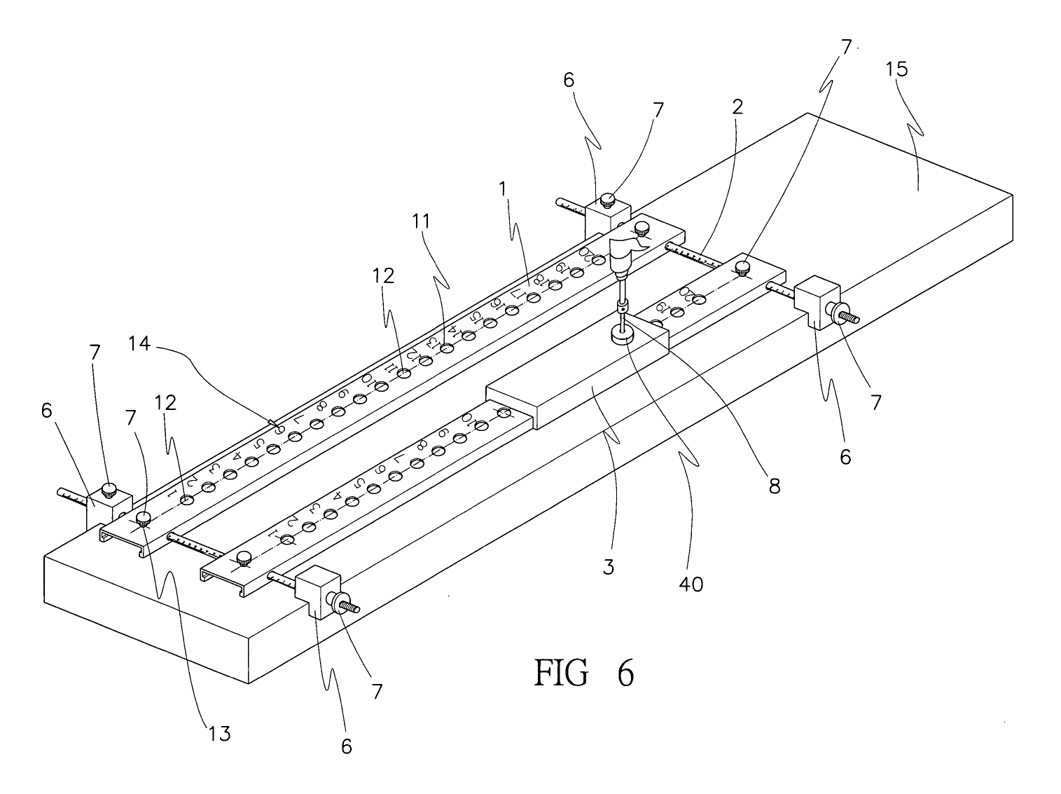

Please refer to FIG. 6. When the lower round body of the boring guide sleeve 40 has been fully screwed into the threaded through hole 31 on the bore-locating block 3, and a boring bit 8 is downward extended into an axial bore provided on the boring guide sleeve 40 for guiding the boring bit 8, the boring bit 8 is rotated in a direction the same as that in which the boring guide sleeve 40 is screwed into the threaded through hole 31. That is, the boring bit 8 is also rotated clockwise to make a bore on the workpiece. This only makes the boring guide sleeve 40 more tightly engaged with the threaded through hole 31 without the risk of a loosened or even separated boring guide sleeve 40 from the threaded through hole 31 during the boring operation due to vibration caused by the boring bit 8. Moreover, boring guide sleeves 40 for forming bores of different diameters on a workpiece could be replaced in a quicker and more convenient manner without using any tool.

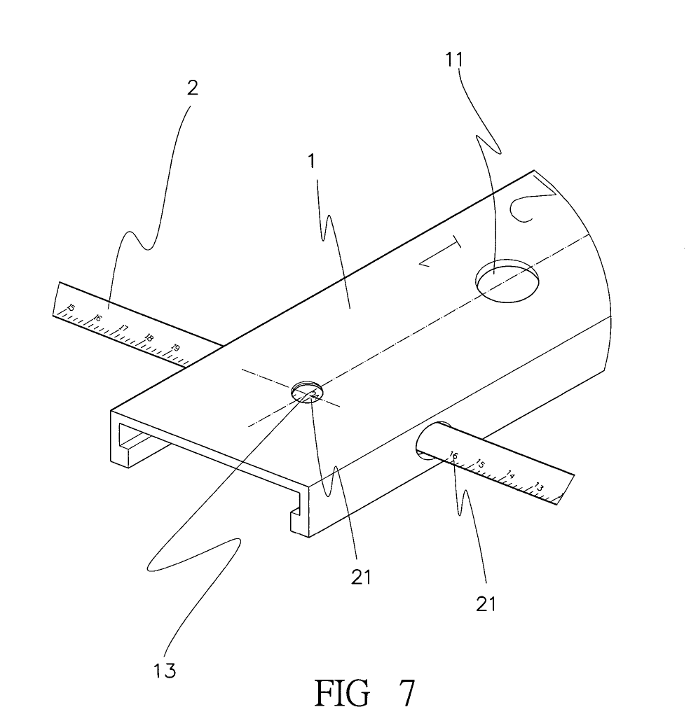

Please refer to FIGS. 6 and 7. The translation-control cross shaft 2 of the present invention is provided along an outer surface with measuring marks 21, and a through screw hole 13 is formed near each longitudinal end of the bore-locating template 1 to locate on a centerline 12 of the row of holes 11 and immediately above the translation-control cross shaft 2, such that a user may observe the measuring marks 21 on the translation-control cross shaft 2 via the screw holes 13. The screw holes 13 also provide positions at where the locking screws 7 are screwed against the translation-control cross shafts 2 and thereby firmly connect the bore-locating template 1 to the translation-control cross shafts 2. The screw holes 13 enable a user to very conveniently determine whether the bore-locating template 1 has been translated to a desired position for boring simply by observing the measuring marks 21 in the screw holes 13 without the need of using a measuring rule.

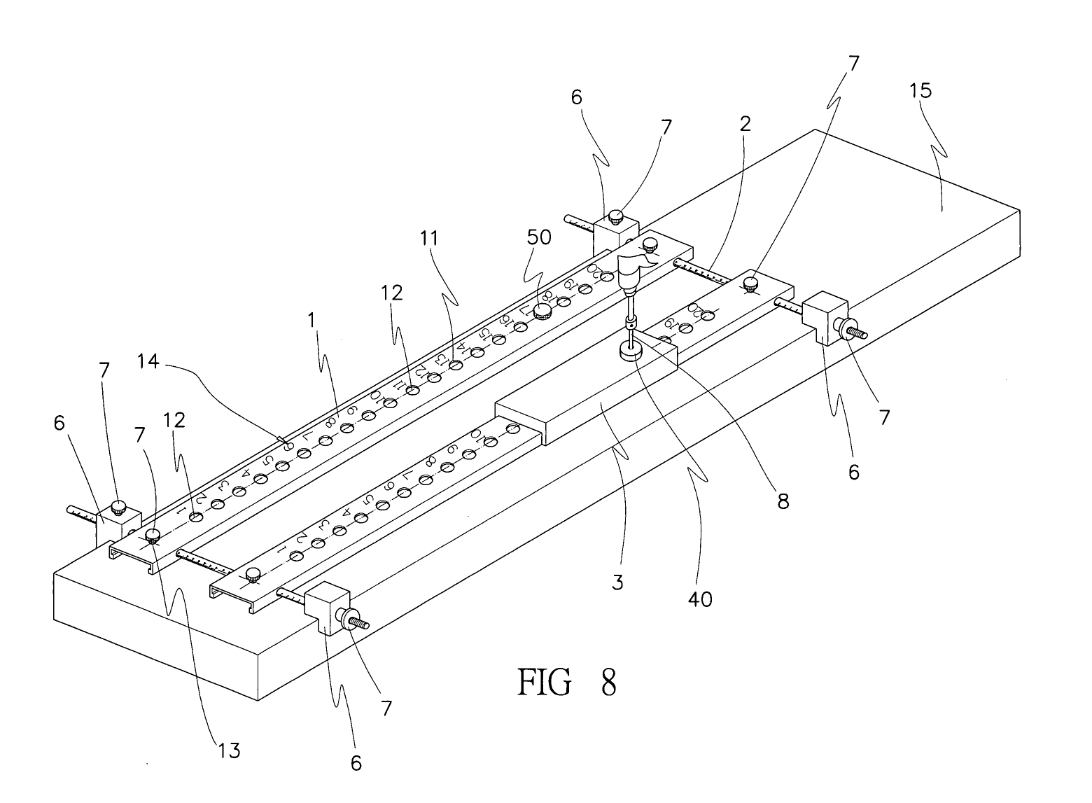

Please refer to FIG. 8. The bore-locating template 1 is also provided on a top surface with sequential numbers 14 corresponding to the row of holes 11 thereon to indicate the sequence of the holes 11. With the numbered holes 11, the peg 50 could be very easily inserted into a numbered hole 11 corresponding to the position at where a bore is to be made. For example, a bore is to be made at a position indicated by the hole 11 with the sequential number of 17. At this point, a user needs only to insert the peg 50 into the hole 11 corresponding to the sequential number 17 without the need of counting the holes 11 one by one from a beginning of the row or the risk of making mistakes in counting the holes 11 on two different bore-locating templates 1 to result in incorrect boring positions on the workpiece.

What is claimed is:

1. A wood boring operation aid for making bores on a workpiece, comprising at least one bore-locating template having a row of spaced holes provided thereon, two translation-control cross shafts connected to two ends of said at least one bore-locating template and locked at two ends to two opposite side of said workpiece, at least one bore-locating block movably mounted on said at least one bore-locating template, at least one boring guide sleeve for fitting into said bore-locating block, at least one peg for selectively inserting into one of said holes on said at least one bore-locating template, at least two sets of mounting blocks for tightly locking said translation-control cross shafts to said workpiece, and a plurality of locking screws for tightening said mounting blocks against said workpiece and said at least one bore-locating template against said translation-control cross shafts; said at least one bore-locating block being provided on a top with an internally threaded through hole, and said at least one boring guide sleeve being provided on an outer surface of a lower round body with threads meshing with said internally threaded through hole on said bore-locating block, such that said boring guide sleeve could be directly screwed into said internally threaded through hole on said bore-locating block and firmly held therein.

2. The wood boring operation aid as claimed in claim 1, wherein said translation-control cross shafts are provided along outer surfaces thereof with measuring marks.

3. The wood boring operation aid as claimed in claim 1, wherein said bore-locating template is provided near each longitudinal end with a through screw hole, which is located on a centerline of said row of holes on said bore-locating template and immediately above said translation-control cross shaft.

4. The wood boring operation aid as claimed in claim 1, wherein said at least one bore-locating template is provided on a top surface with sequential numbers corresponding to said row of holes.
